(19) United States
(12) Patent Application Publication
(10) Pub. No.: US 2005/0102690 A1
(43) Pub. Date: May 12, 2005

(54) Optical disk drive capable of dissipating heat and proofing against dust

(76) Inventor: Chiu-An Huang, Baojhong Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/978,325

(22) Filed: Nov. 1, 2004

(30) Foreign Application Priority Data
Nov. 6, 2003 (TW) 92131151

(51) Int. Cl. G11B 33/14

(52) U.S. Cl. 720/649; 720/648

(57) ABSTRACT

An optical disk drive is provided. The optical disk drive includes a housing, a chassis and an elastic dust-proof slice. The housing includes a top plate and a bottom plate. The chassis, which is deposited inside the housing, includes a lateral plate wherein the lateral plate has an airflow exit for dissipating heat. The elastic dust-proof slice is swimmingly deposited on the lateral plate for closing or opening the airflow exit. In natural situation, the elastic dust-proof slice is located on a shielding position and closes the airflow exit. When a hot airflow generated inside the optical disk drive flows to the airflow exit, the elastic dust-proof slice is pushed by the hot airflow and swung away from the outside surface of the lateral plate. As a result, the airflow exit is opened and the hot airflow flows out of the chassis via the opened airflow exit.

This application claims the benefit of Taiwan application Serial No. 92131151, filed Nov. 6, 2003, the subject matter of which is incorporated herein by reference.

### BACKGROUND OF THE INVENTION

1. Field of the Invention

The invention relates in general to an optical disk drive, and more particularly to an optical disk drive capable of dissipating heat and proofing against dust.

### DESCRIPTION OF THE RELATED ART

Living in today's society where science and technology are gaining rapid advance and are being constantly renewed, high capacity optical disks have become an important software carriage to modern people's everyday life as the application of computer software, music and pictures are becoming more and more popular. Optical disks, which have two major categories: the CD and the DVD, have won a great popularity due to the features of high capacity, small volume and security in data storage. Consequently, the optical disk drive, which reads CD or DVD, has thus become an essential part of personal computer.

Refer to FIG. 1A and FIG. 1B at the same time. FIG. 1A is a partial top view of a conventional optical disk drive, while FIG. 1B is a partial sectional view of the optical disk drive in FIG. 1A along the section line 1B-1B′. In FIG. 1A and FIG. 1B, an optical disk drive 10 includes a housing 12, a chassis 13, a spindle motor 11 and a flow guiding plate 19. The chassis 13 is deposited inside the housing 12 and has a lateral plate 14. The lateral plate 14 of the chassis 13 has an airflow exit 16. The spindle motor 11 is deposited inside the chassis 13 for carrying an optical disk 18 and driving the optical disk 18 to rotate. The flow guiding plate 19 is deposited inside the chassis 13 or on the inner wall of the top plate of the housing 12 for guiding the hot airflow 17 generated during the rotation of the optical disk 18 to the airflow exit 16, so that the hot airflow 17 may be easily dissipated out of the optical disk drive 10.

Despite having the advantage of dissipating the hot airflow 17 generated inside the optical disk drive 10, the design of having an airflow exit 17 on the lateral plate 14 of the chassis 13 has its disadvantages. Particles, dusts or objects from outside may easily enter into the optical disk drive 10 via the airflow exit 17, tarnishing and making the optical pick-up head unable to read the data stored in the optical disk or tarnishing and causing malfunction to other parts.

### SUMMARY OF THE INVENTION

It is therefore an object of the invention to provide an optical disk drive capable of dissipating heat and proofing against dust using an elastic dust-proof slice to close or open the airflow exit. At one hand, this design dissipates the hot airflow generated inside the optical disk drive via the airflow exit; at the other hand, this design prevents external particles, dusts or objects from entering into the optical disk drive via the airflow exit and protects the internal parts of the optical disk drive from being tarnished, so that quality operation of the optical disk drive is maintained.

It is another object of the invention to provide an optical disk drive capable of dissipating heat and proofing against dust. The optical disk drive includes at least a housing, a chassis and an elastic dust-proof slice. The housing includes a top plate and a bottom plate. The chassis, which is deposited inside the housing, includes a lateral plate, wherein the lateral plate of the chassis has an airflow exit for dissipating heat. The elastic dust-proof slice is swimmingly deposited on the lateral plate for closing or opening the airflow exit. In natural situation, the elastic dust-proof slice is located on a shielding position and closes the airflow exit. When a hot airflow generated inside the optical disk drive flows to the airflow exit, the elastic dust-proof slice is pushed by the hot airflow and swings away from the outside surface of the lateral plate of the chassis. As a result, the airflow exit is opened and the hot airflow flows out of the chassis via the opened airflow exit.

It is another object of the invention to provide an optical disk drive capable of dissipating heat and proofing against dust. The optical disk drive includes at least a housing and an elastic dust-proof slice. The housing includes a top plate and a lateral plate, wherein the lateral plate of the housing has an airflow exit. The elastic dust-proof slice is swimmingly deposited on the lateral plate for closing or opening the airflow exit. In natural situation, the elastic dust-proof slice is located on a shielding position and closes the airflow exit. When a hot airflow generated inside the optical disk drive flows to the airflow exit, the elastic dust-proof slice is pushed by the hot airflow and swings away from the outside surface of the lateral plate of the housing. As a result, the airflow exit is opened and the hot airflow flows out of the housing via the opened airflow exit.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A(Prior Art) is a partial top view of a conventional optical disk drive;

FIG. 1B(Prior Art) is a partial sectional view of the optical disk drive in FIG. 1A along the section line 1B-1B′;

FIG. 2A is a partial top view of an optical disk drive capable of dissipating heat and proofing against dust according to preferred embodiment one of the invention;

FIG. 2B is a partial sectional view of the optical disk drive in FIG. 2A along the section line 2B-2B′;

FIG. 2C is a diagram showing the status when the elastic dust-proof slice in FIG. 2B is pushed by a hot airflow;

FIG. 2D is a diagram showing the status when the elastic dust-proof slice in FIG. 2B closes the airflow exit after the hot airflow is dissipated;

FIG. 3 is a partial sectional view of an optical disk drive capable of dissipating heat and proofing against dust according to preferred embodiment two of the invention;

FIG. 4A is a partial top view of an optical disk drive capable of dissipating heat and proofing against dust according to preferred embodiment three of the invention;

FIG. 4B is a partial sectional view of the optical disk drive in FIG. 4A along the section line 4B-4B′; and

FIG. 5 is a partial sectional view of an optical disk drive capable of dissipating heat and proofing against dust according to preferred embodiment four of the invention.

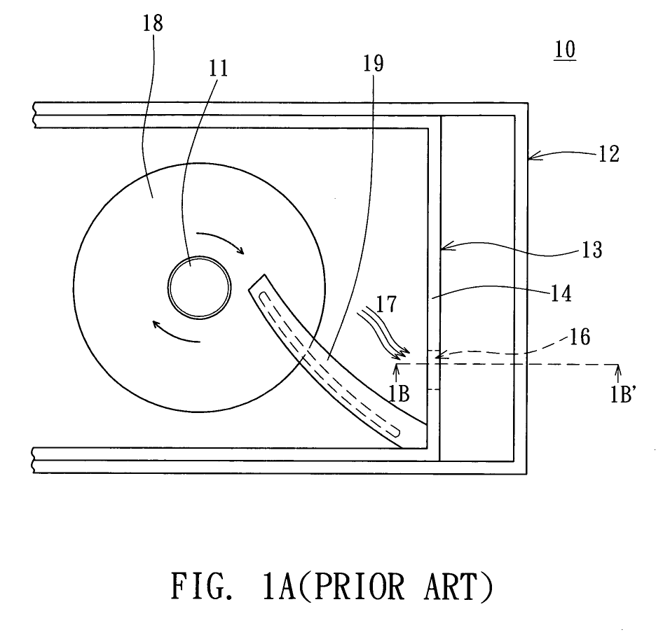

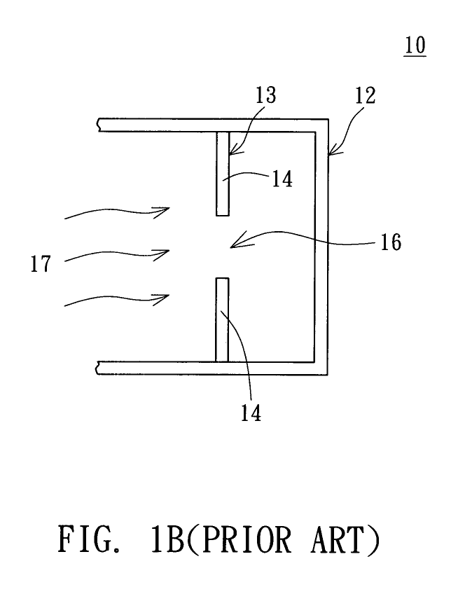

### DETAILED DESCRIPTION OF THE INVENTION

### Preferred Embodiment One

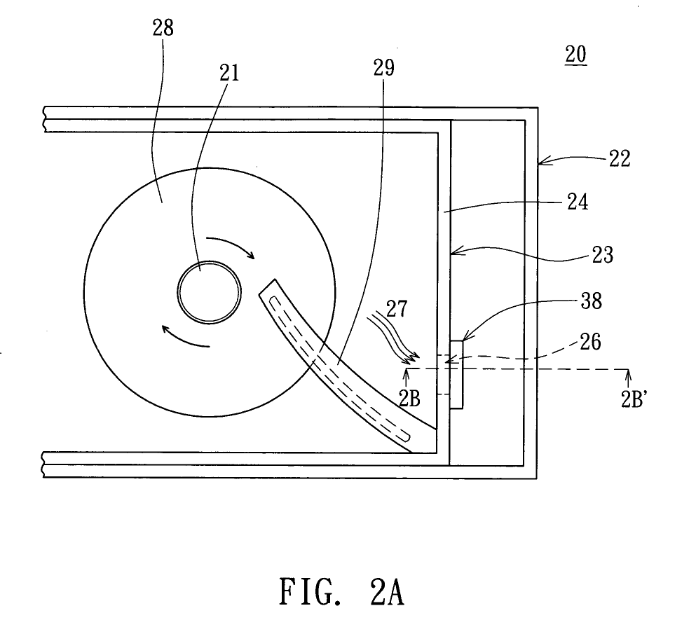

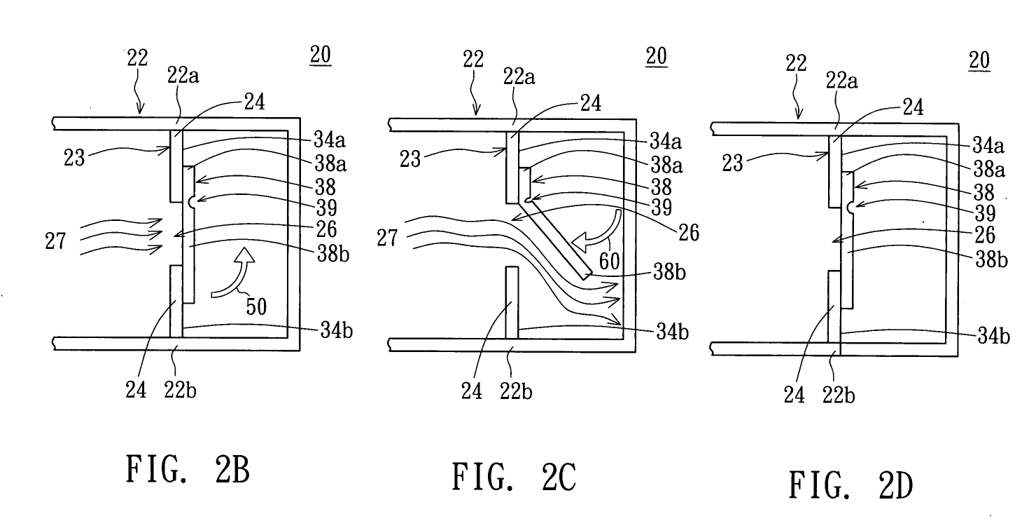

Referring to FIG. 2A and FIG. 2B, a partial top view of an optical disk drive capable of dissipating heat and proofing against dust according to preferred embodiment one of the invention and a partial top view of an optical disk drive capable of dissipating heat and proofing against dust according to preferred embodiment one of the invention are shown. In FIG. 2A and FIG. 2B, an optical disk drive 20 includes at least a housing 22, a chassis 23, a spindle motor 21, a flow guiding plate 29 and an elastic dust-proof slice 38. The housing 22 has a top plate 22a and a bottom plate 22b. The chassis 23 is deposited inside the housing 22 and has a lateral plate 24. The lateral plate 24 has an upper vertical surface 34a and a lower vertical surface 34b, both of which are perpendicular to the bottom plate 22b, and an airflow exit 26. The upper vertical surface 34a is deposited between the top plate 22a and the airflow exit 26 while the lower vertical surface 34b is deposited between the bottom plate 22b and the airflow exit 26. The spindle motor 21 is deposited inside the chassis 23 for carrying an optical disk 28 and further driving the optical disk 28 to rotate. The flow guiding plate 29 is deposited inside the chassis 23 or on the inner wall of the top plate 22a for guiding a hot airflow 27 generated during the rotation of the optical disk 28 to the airflow exit 26.

The elastic dust-proof slice 38 is deposited on the lateral plate 24 and includes a linking portion 38a and a shielding portion 38b. The linking portion 38a and the shielding portion 38b are jointed together. The linking portion 38a is adhered onto the upper vertical surface 34a while the shielding portion 38b is swimmingly jointed to the linking portion 38a and may swing along an arrow 50 in FIG. 2B for opening or closing the airflow exit 26. The tail end of the shielding portion 38b touches the lower vertical surface 34b when the shielding portion 38b closes the airflow exit 26 and is perpendicular to the surface of the bottom plate 22b. It is noteworthy that the design of having a surface indentation 39 formed at the junction of the linking portion 38a and the shielding portion 38b makes it easier for the shielding portion 38b to swing against the linking portion 38a. However, anyone who is familiar with the technology of the invention will realize that the invention is not limited thereto. For example, the elastic dust-proof slice 38 may be made of rubber or other elastic materials formed in one block.

In natural situation, the shielding portion 38b is located on a shielding position and closes the airflow exit 26 as shown in FIG. 2B, preventing external particles, dusts or objects from entering into the optical disk drive 20 via the airflow exit 26 and protecting the internal parts of the optical disk drive 20 from being tarnished, so that quality operation of the optical disk drive 20 is maintained.

When a hot airflow 27 generated inside the optical disk drive 20 in FIG. 2A flows to the airflow exit 26, the shielding portion 38b in FIG. 2B is pushed by the hot airflow 27 and swings away from the lateral plate 24. As a result, the airflow exit 26 is opened and the hot airflow 27 flows out of the chassis 23 via the opened airflow exit 26 as shown in FIG. 2C.

After the optical disk drive 20 stops and the hot airflow 27 in FIG. 2C is gradually dissipated outside the chassis 23, the shielding portion 38b, by means of the gravity and its own elasticity, automatically swings back to the shielding position along an arrow 60 of FIG. 2C and closes the airflow exit 26 as shown in FIG. 2D.

### Preferred Embodiment Two

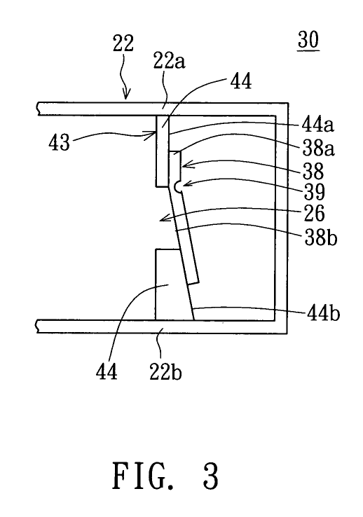

Referring to FIG. 3, a partial sectional view of an optical disk drive capable of dissipating heat and proofing against dust according to preferred embodiment two of the invention is shown. The structure the optical disk drive 30 in preferred embodiment two differs from the optical disk drive 20 in preferred embodiment one in that the lateral plate 44 of the chassis 43 has an upper vertical surface 44a being perpendicular to the surface of the bottom plate 22b and a lower inclined surface 44b being inclined to the surface of the bottom plate 22b. The upper vertical surface 44 is deposited between the top plate 22a and the airflow exit 26 for the linking portion 38a to be adhered onto. The lower inclined surface 44b is deposited between the bottom plate 22b and the airflow exit 26 for touching the tail end of the shielding portion 38b when the shielding portion 38b closes the airflow exit 26 and inclines towards the surface of the bottom plate 22b. As for the similarities between the optical disk drive 30 in preferred embodiment two and the optical disk drive 20 in preferred embodiment one are not repeated here.

### Preferred Embodiment Three

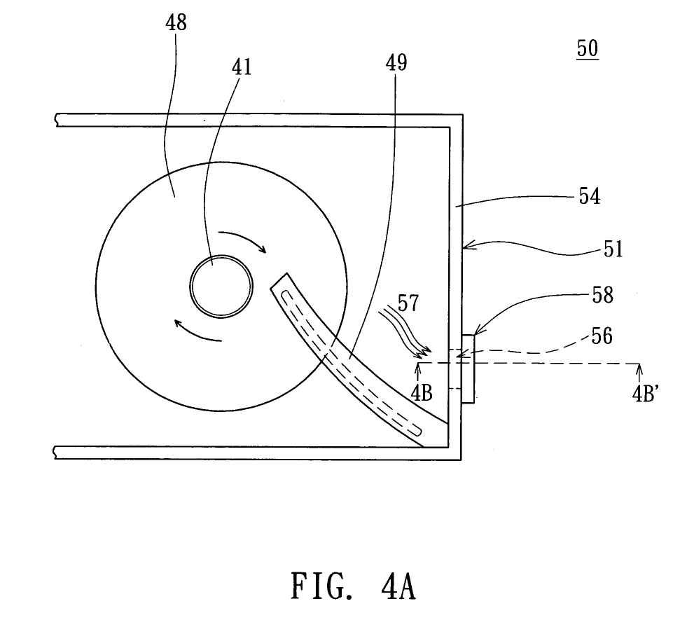

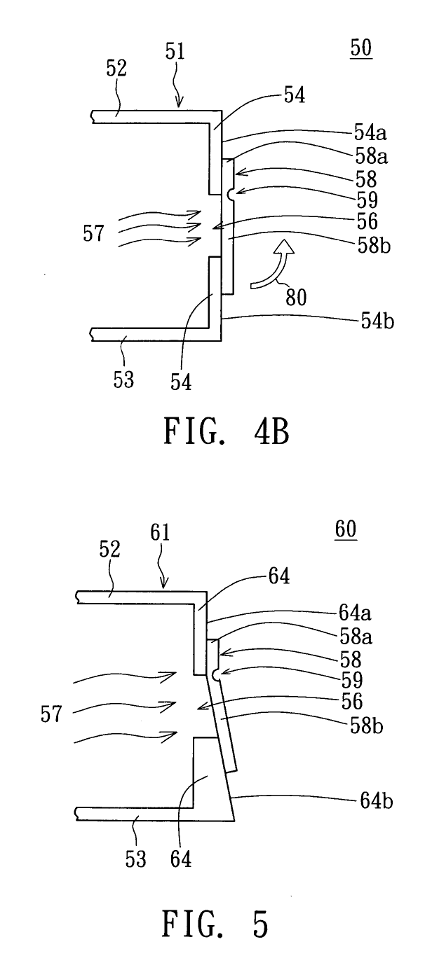

Referring to FIG. 4A and FIG. 4B, a partial top view of an optical disk drive capable of dissipating heat and proofing against dust according to preferred embodiment three of the invention and a partial sectional view of the optical disk drive in FIG. 4A along the section line 4B-4B′ are shown. In FIG. 4A and FIG. 4B, an optical disk drive 50 includes at least a housing 51, a spindle motor 41, a flow guiding plate 49 and an elastic dust-proof slice 58. The housing 51 has a top plate 52, a bottom plate 53 and a lateral plate 54. The lateral plate 54 connects the top plate 52 and the bottom plate 53. The lateral plate 54 has an upper vertical surface 54a and a lower vertical surface 54b, both of which are perpendicular to the surface of the bottom plate 53, and an airflow exit 56. The upper vertical surface 54a is deposited between the top plate 52 and the airflow exit 56 while the lower vertical surface 54b is deposited between the bottom plate 53 and the airflow exit 56. The spindle motor 41 is deposited inside the housing 51 for carrying an optical disk 48 and further driving the optical disk 48 to rotate. The flow guiding plate 49 is deposited inside the housing 51 or on the inner wall of the top plate 52 for guiding a hot airflow 57 generated during the rotation of the optical disk 48 to the airflow exit 56.

The elastic dust-proof slice 58 is deposited on the lateral plate 54 and includes a linking portion 58a and a shielding portion 58b. The linking portion 58a and the shielding portion 58b are jointed together. The linking portion 58a is adhered onto the upper vertical surface 54a while the shielding portion 58b is swimmingly jointed to the linking portion 59a and may swing along an arrow 80 in FIG. 4B for opening or closing the airflow exit 56. The tail end of the shielding portion 58b touches the lower vertical surface 54b when the shielding portion 58b closes the airflow exit 56 and is perpendicular to the surface of the bottom plate 53. It is noteworthy that the design of having a surface indentation 59 formed at the junction of the linking portion 58a and the shielding portion 58b makes it easier for the shielding portion 58b to swing against the linking portion 58a. However, anyone who is familiar with the technology of the invention will realize that the invention is not limited thereto. For example, the elastic dust-proof slice 58 may be made of rubber or other elastic materials formed in one block.

In natural situation, the shielding portion 58b is located on a shielding position and closes the airflow exit 56, preventing external particles, dusts or objects from entering into the optical disk drive 50 via the airflow exit 56. When a hot airflow 57 generated inside the optical disk drive 50 flows to the airflow exit 56, the shielding portion 58b is pushed by the hot airflow 57 and swings away from the lateral plate 54 along the arrow 80 of FIG. 4B. As a result, the airflow exit 56 is opened and the hot airflow 57 flows out of the housing 51 via the opened airflow exit 56. After the optical disk drive 50 stops and the hot airflow 57 is gradually dissipated outside the housing 51, the shielding portion 58b, by means of the gravity and its own elasticity, automatically swings back to the shielding position and closes the airflow exit 56.

### Preferred Embodiment Four

Referring to FIG. 5, a partial sectional view of an optical disk drive capable of dissipating heat and proofing against dust according to preferred embodiment four of the invention is shown. The structure the optical disk drive 60 in preferred embodiment four differs from the optical disk drive 50 in preferred embodiment three in that the lateral plate 64 of the housing 61 has an upper vertical surface 64a being perpendicular to the surface of the bottom plate 53 and a lower inclined surface 64b being inclined to the surface of the bottom plate 53. The upper vertical surface 64 is deposited between the top plate 52 and the airflow exit 56 for the linking portion 58a to be adhered onto. The lower inclined surface 64b is deposited between the bottom plate 53b and the airflow exit 56 for touching the tail end of the shielding portion 58b when the shielding portion 58b closes the airflow exit 56 and inclines towards the surface of the bottom plate 53. As for the similarities between the optical disk drive 60 in preferred embodiment four and the optical disk drive 50 in preferred embodiment three are not repeated here.

However, anyone who is familiar with the technology of the invention will realize that the invention is not limited thereto. For example, the elastic dust-proof slice may be made of rubber or other elastic materials formed in one block.

According to the object of the invention, an optical disk drive capable of dissipating heat and proofing against dust using an elastic dust-proof slice to close or open the airflow exit is disclosed in above preferred embodiments. At one hand, this design dissipates the hot airflow generated inside the optical disk drive via the airflow exit; at the other hand, this design prevents external dusts or objects from entering into the optical disk drive via the airflow exit and protects the internal parts of the optical disk drive from being tarnished so that quality operation of the optical disk drive is maintained.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An optical disk drive capable of dissipating heat and proofing against dust comprising at least:
a housing having a top plate and a bottom plate;
a chassis having a lateral plate deposited inside the housing, wherein the lateral plate has an airflow exit for dissipating heat; and
an elastic dust-proof slice swimmingly deposited on the lateral plate of the chassis for closing or opening the airflow exit;
in natural situation, the elastic dust-proof slice is located on a shielding position and closes the airflow exit;
when a hot airflow generated inside the optical disk drive flows to the airflow exit, the elastic dust-proof slice is pushed by the hot airflow and swings away from the outside surface of the lateral plate, so that the airflow exit is opened and the hot airflow flows out of the chassis via the opened airflow exit.

2. The optical disk drive according to claim 1, wherein the lateral plate has an upper vertical surface and a lower vertical surface, both of which are substantially perpendicular to the bottom plate, the upper vertical surface is deposited between the top plate and the airflow exit while the lower vertical surface is deposited between the bottom plate and the airflow exit.

3. The optical disk drive according to claim 2, wherein the elastic dust-proof slice further comprises:
a linking portion deposited on the upper vertical surface; and
a shielding portion swimmingly jointed to the linking portion for opening or closing the airflow exit, wherein the tail end of the shielding portion touches the lower vertical surface when the shielding portion closes the airflow exit and is perpendicular to the surface of the bottom plate.

4. The optical disk drive according to claim 3, wherein a surface indentation is formed at the junction of the linking portion and the shielding portion for the shielding portion to swing against the linking portion.

5. The optical disk drive according to claim 3, wherein the area of the shielding portion is substantially larger than the area of the opening of the airflow exit.

6. The optical disk drive according to claim 1, wherein the lateral plate has an upper vertical surface being substantially perpendicular to the surface of the bottom plate and a lower inclined surface being inclined to the surface of the bottom plate, the upper vertical surface is deposited between the top plate and the airflow exit while the lower inclined surface is deposited between the bottom plate and the airflow exit.

7. The optical disk drive according to claim 6, wherein the elastic dust-proof slice further comprises:
a linking portion deposited on the upper vertical surface; and
a shielding portion swimmingly jointed to the linking portion for opening or closing the airflow exit, wherein the tail end of the shielding portion touches the lower inclined surface when the shielding portion closes the airflow exit closes the airflow exit and inclines towards the surface of the bottom plate.

8. The optical disk drive according to claim 7, wherein a surface indentation is formed at the junction of the linking portion and the shielding portion for the shielding portion to swing against the linking portion.

9. The optical disk drive according to claim 7, wherein the area of the shielding portion is substantially larger than the area of the opening of the airflow exit.

10. The optical disk drive according to claim 1, wherein the elastic dust-proof slice is made of rubber and is formed in one block.

11. The optical disk drive according to claim 1, wherein the optical disk drive further comprises:
a spindle motor deposited inside the chassis for driving an optical disk; and
a flow guiding plate deposited inside the chassis or on the inner wall of the top plate for guiding the hot airflow generated during the rotation of the disk to flow to the airflow exit.

12. An optical disk drive capable of dissipating heat and proofing against dust comprising at least:
a housing having a top plate and a lateral plate, wherein the lateral plate has an airflow exit for dissipating heat; and
an elastic dust-proof slice swimmingly deposited on the lateral plate for closing or opening the airflow exit;
in natural situation, the elastic dust-proof slice is located on a shielding position and closes the airflow exit;
when a hot airflow generated inside the optical disk drive flows to the airflow exit, the elastic dust-proof slice is pushed by the hot airflow and swings away from the outside surface of the lateral plate, so that the airflow exit is opened and the hot airflow flows out of the housing via the opened airflow exit.

13. The optical disk drive according to claim 12, wherein the housing further has a bottom plate, which is jointed to the top plate by the lateral plate, the lateral plate further has an upper vertical surface and a lower vertical surface, both of which are substantially perpendicular to the bottom plate, the upper vertical surface is deposited between the top plate and the airflow exit while the lower vertical surface is deposited between the bottom plate and the airflow exit.

14. The optical disk drive according to claim 13, wherein the elastic dust-proof slice further comprises:
a linking portion deposited on the upper vertical surface; and
a shielding portion swimmingly jointed to the linking portion for opening or closing the airflow exit, wherein the tail end of the shielding portion touches the lower vertical surface when the shielding portion closes the airflow exit and is perpendicular to the surface of the bottom plate.

15. The optical disk drive according to claim 14, wherein a surface indentation is formed at the junction of the linking portion and the shielding for the shielding portion to swing against the linking portion.

16. The optical disk drive according to claim 12, wherein the housing further has a bottom plate, which is jointed to the top plate by the lateral plate, the lateral plate further has an upper vertical surface being substantially perpendicular to the surface of the bottom plate and a lower inclined surface being inclined to the surface of the bottom plate, the upper vertical surface is deposited between the top plate and the airflow exit while the lower inclined surface is deposited between the bottom plate and the airflow exit.

17. The optical disk drive according to claim 16, wherein the elastic dust-proof slice further comprises:
a linking portion deposited on the upper vertical surface; and
a shielding portion swimmingly jointed to the linking portion for opening or closing the airflow exit, wherein the tail end of the shielding portion touches the lower inclined surface when the shielding portion closes the airflow exit closes the airflow exit and inclines towards the surface of the bottom plate.

18. The optical disk drive according to claim 17, wherein a surface indentation is formed at the junction of the linking portion and the shielding portion for the shielding portion to swing against the linking portion.

19. The optical disk drive according to claim 12, wherein the elastic dust-proof slice is made of rubber and is formed in one block.

20. The optical disk drive according to claim 12, wherein the optical disk drive further comprises:
a spindle motor deposited inside the housing for driving an optical disk; and
a flow guiding plate deposited inside the housing or on the inner wall of the top plate of the housing for guiding the hot airflow generated during the rotation of the disk to flow to the airflow exit.
